(19) United States
(12) Patent Application Publication
(10) Pub. No.: US 2010/0235361 A1
(43) Pub. Date: Sep. 16, 2010

(54) Optimizing Questionnaires

(75) Inventors: Anish Chandran, Bangalore (IN); Kiran Hariharan Nair, Trivandrum (IN); Deepak S. Padmanabhan, Kerala (IN)

Correspondence Address: KALI LAW GROUP, P.C., P.O. BOX 60187, SUNNYVALE, CA, 94088-0187, US

(73) Assignee: International Business Machines Corporation, Armonk, NY (US)

(21) Appl. No.: 12/402,697

(22) Filed: Mar. 12, 2009

(51) Int. Cl. G06F 7/10; G06F 17/30; G06N 5/02

(52) U.S. Cl. 707/748; 706/46; 707/E17.044; 707/E17.059

(57) ABSTRACT

Online and other electronic surveys are increasingly being looked upon as highly useful and versatile tools for gauging popular opinions in a variety of areas. Challenges continually arise in terms of optimizing questionnaires so as to maximize their effectiveness in mapping trends among a population over time. There is broadly contemplated herein, in accordance with at least one embodiment, of the invention, the automation of the usage of value dependencies by way of exposing and eliminating redundancy in survey or questionnaire databases. Dynamically, updated information can be used to continuously evolve a selection of questions, while fairness can be ensured in this selection by averting a situation of continual non-selection of certain questions.

### BACKGROUND

Online and other electronic surveys are increasingly being looked upon as highly useful and versatile tools for gauging popular opinions in a variety of areas. Challenges continually arise in terms of optimizing questionnaires so as to maximize their effectiveness in mapping trends among a population over time.

### SUMMARY

There is broadly contemplated herein, in accordance with at least one embodiment of the invention, the automation of the usage of value dependencies by way of exposing and eliminating redundancy in survey or questionnaire databases. Dynamically, updated information can be used to continuously evolve a selection of questions, while fairness can be ensured in this selection by averting a situation of continual non-selection of certain questions.

In summary, this disclosure describes a method including providing a questionnaire to a respondent, the providing comprising selecting questions from a question repository, obtaining questionnaire answers from the respondent, revising the questionnaire based on previous answers from respondents, the revising comprising newly selecting questions from the question repository.

This disclosure also describes an apparatus comprising: a main memory; an optimization engine in communication with the main memory; the optimization engine acting to: provide a questionnaire to respondents, the questionnaire comprising questions selected from a question repository; obtain answers to the questionnaire from the respondents; and automatically reestablish the questionnaire based on previous answers from respondents.

Furthermore, this disclosure additionally describes a program storage device readable by machine, tangibly embodying a program of instructions executable by the machine to perform a method comprising: providing a questionnaire to respondents, the questionnaire comprising questions selected from a question repository; obtaining answers to the questionnaire from the respondents; and automatically reestablishing the questionnaire based on previous answers from respondents.

### BRIEF DESCRIPTION OF THE SEVERAL VIEWS OF THE DRAWINGS

FIG. 1 schematically illustrates a computer system with which a preferred embodiment of the present invention can be used.

FIG. 2 illustrates, in schematic form, a survey/questionnaire optimization arrangement.

FIGS. 3 and 4 provide different renditions of the same table of numerical answers provided to several questions by several respondents.

### DETAILED DESCRIPTION

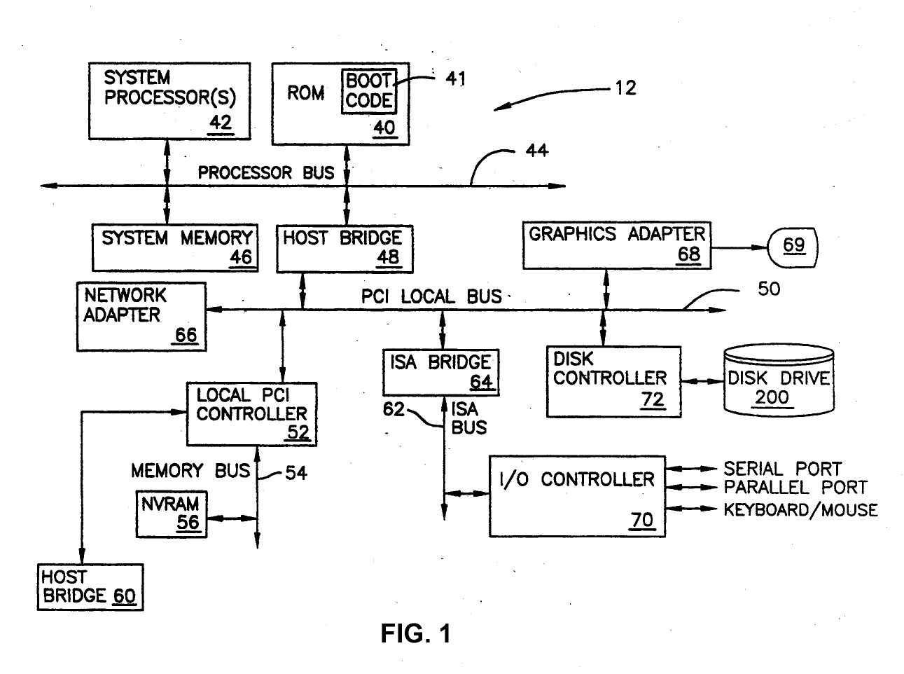

It will be readily understood that the embodiments of the invention, as generally described and illustrated in the Figures herein, may be arranged and designed in a wide variety of different configurations. Thus, the following more detailed description of the embodiments of the apparatus, system, and method of the embodiments of the invention, as represented in FIGS. 1-4, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to 2to the same embodiment.

Furthermore, the described features, structures, or characteristics may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring aspects of embodiments of the invention.

The illustrated embodiments of the invention will be best understood by reference to the drawings, wherein like parts are designated by like numerals or other labels throughout. The following description is intended only by way of example, and simply illustrates certain selected embodiments of devices, systems, and processes.

Referring now to FIG. 1, there is depicted a block diagram of an embodiment of a computer system 12. The embodiment depicted in FIG. 1 may be a notebook computer system, such as one of the ThinkPad® series of personal computers previously sold by the International Business Machines Corporation of Armonk, N.Y., and now sold by Lenovo (US) Inc. of Morrisville, N.C.; however, as will become apparent from the following description, the embodiments of the invention may be applicable to any data processing system. Notebook computers, as may be generally referred to or understood herein, may also alternatively be referred to as “notebooks”, “laptops”, “laptop computers” or “mobile computers”.

As shown in FIG. 1, computer system 12 includes at least one system processor 42, which is coupled to a Read-Only Memory (ROM) 40 and a system memory 46 by a processor bus 44. System processor 42, which may comprise one of the AMD™ line of processors produced by AMD Corporation or a processor produced by Intel Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to a local area network (LAN), and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard and mouse. In addition, I/O controller 70 supports external communication by computer system 12 via serial and parallel ports, including communication over a wide area network (WAN) such as the Internet. A disk controller 72 is in communication with a disk drive 200 for accessing external memory. Of course, it should he appreciated that the system 12 may be built with different chip sets and a different bus structure, as well as with any other suitable substitute components, while providing comparable or analogous functions to those discussed above.

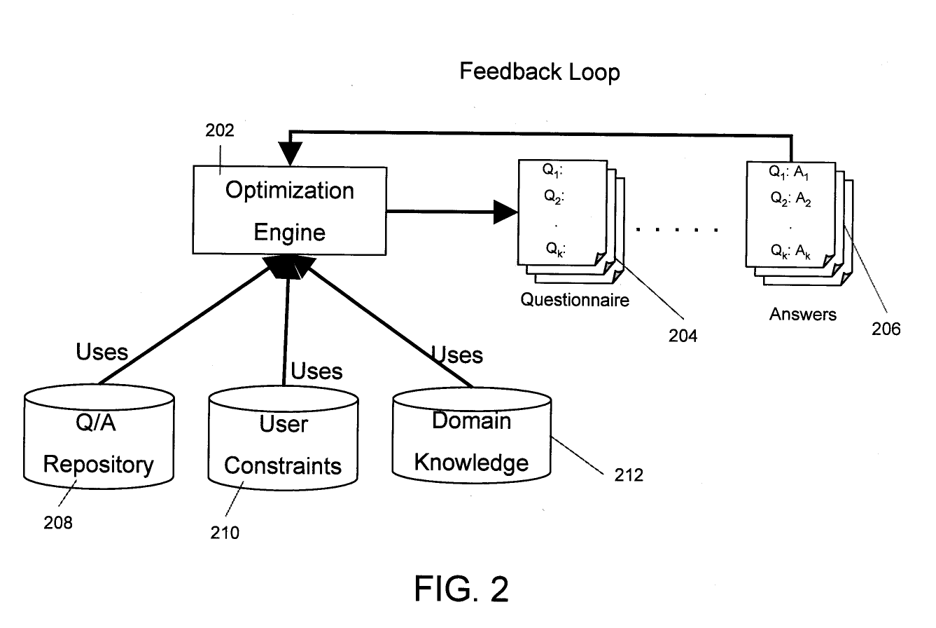

Reference may now be made here throughout to FIGS. 2-4 by way of understanding and appreciating embodiments of the present invention, which may employ a computer system such as that indicated at 12 in FIG. 1 or, alternatively, any of a very wide variety of other suitable computer systems. As such, the computer system presented in FIG. 1 is presented by way of illustrative and non-restrictive example and is not to be construed as limiting upon the possible environments in which embodiments of the present invention, now to be discussed, may be employed.

This disclosure broadly embraces, in accordance with at least one embodiment, an optimization of formulating the makeup of a survey or questionnaire based on historical data. Generally, a task to he confronted is in choosing a subset from a (relatively large) pool of pre-defined questions (each having finite-answer sets) in opinion gathering mechanisms (e.g., surveys) while optimizing on several criteria, including: minimizing (or at least keeping to a manageable level) the number of questions to reduce user reluctance to participate in the opinion gathering process; maximizing (or at least increasing) the amount of information gathered from users using historical response patterns; and constantly and automatically evolving the questionnaire to adapt to changing user response patterns.

FIG. 2 broadly illustrates, in schematic form, a survey/questionnaire optimization arrangement in accordance with an embodiment of the invention. Generally, an optimization engine 202, performing the optimization tasks just described, can accept historical data in the form of answers 206 in order to newly form or revise a questionnaire 204. Newly obtained answers 206 to a questionnaire 204, in turn, can essentially be “fed” back to optimization engine 202 in a “feedback loop” to hone the questionnaire 204 even further (in accordance with the predetermined optimization criteria). Constraints on the optimization can be provided in many forms including, but by no means limited to, user constraints 210 and domain knowledge 212. The questions themselves can originate from a repository 208, whereby a limited number of questions from the repository 208 may end up on a questionnaire 204 via action of the optimization engine 202.

The target population for a given repository 208 of Q & A (questions and answers) can introduce a set of value dependencies (or association rules) among certain questions, thus inducing redundancies in the repository 208. Thus, the optimization engine 202 can act to select questions in a way to eliminate redundancy with a minimal loss of useful information.

As a matter of further refinement, behavioral patterns of the target population can of course evolve over time in response to factors intrinsic or extrinsic to the population. In this light, any changes in behavioral patterns in the target population (as discovered from respondents' answers) can be used to refine the set of questions selected from the repository 208.

Generally, a value dependency is said to exist when a specific answer to a question determines a specific answer to another question:

(A=a1)·(B=b1)

i.e., for all surveys which have the answer a1 to the question A, the answer to the question B is b1. “Approximate value dependencies” can be said to exist when, for all the surveys which have the answer a1 to A, the answers to B have a non-random distribution.

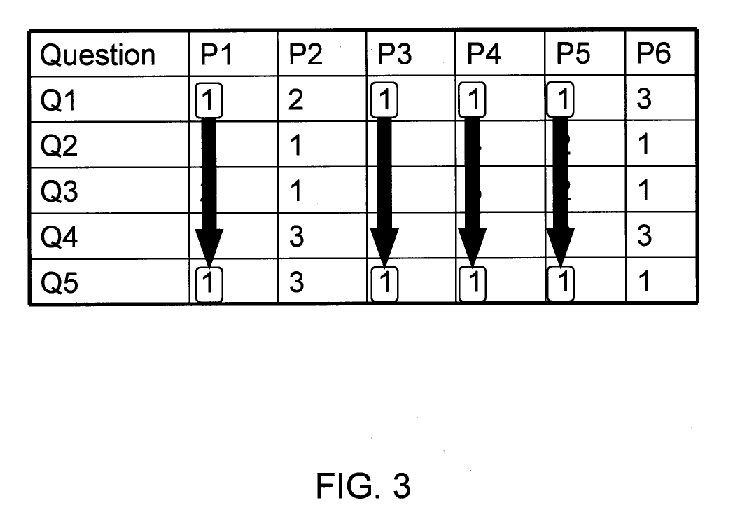

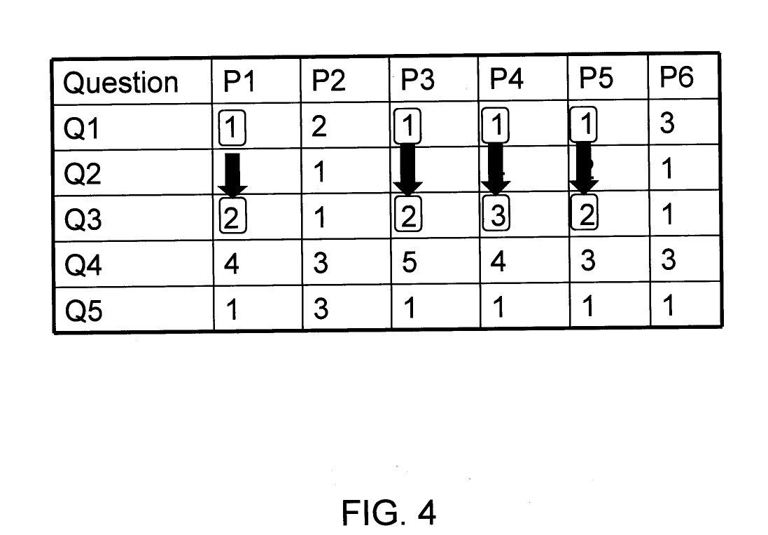

FIGS. 3 and 4 provide different renditions of the same table of numerical answers provided to several questions (Q1, Q2 . . . ) by several respondents (P1, P2 . . . ). As shown by the boxed values. FIG. 3 depicts a discovered value relationship of (Q1=1)·(Q5−1). FIG. 4, on the other hand, depicts a discovered approximate value relationship of (Q2=1)·(Q3={1,2}); this is because the distribution of answers to Q3 for those entries where Q2 is answered as 1 is not uniform over all the possible answers to Q3

Towards optimization of a questionnaire, the cost of discovering value relationships can be expressed as follows;
For each question, for each answer value, examine the answers for all other questions and find their distribution.
Σ_{qεQ} Σ_{aεAns(q)}|Q*|U|
Which is computationally O(|O|²|U|A)
Where Q is the set of question, U the set of respondents and A the average number of possible answers per question.

As such, the predictive power of a particular question with respect to another can be quantified based using the response database in a manner now to be described. Consider the question Q1 with a response set {a1, a2, . . . , a5} and another question Q2 with a response set {b1, b2, . . . , b5}. To compute the predictive power of individual responses of Q1, consider the array R^{Q2}ₐ₁=<C_{b1}, C_{b2}, . . . , C_{b5}> where C_{bi}=number of people who have answered bi to the question Q2 among those who have answered a1 to Q1.

The entropy of this array (denoted as E(R^{Q2}ₐ₁)) is inversely related to the predictive power of the response a1 (to Q1) on the response to the question Q2

Consider next the array <E(R^{Q2}ₐ₁), E(R^{Q2}ₐ₂), . . . E(R^{Q2}ₐ₅)>, whereby the sum of this array is inversely related to the predictive power of the responses of Q1 on the responses of Q2. PR(Q1, Q2) can now be used to represent this quantification of the predictive power of the responses of Q1 on the responses of Q2

To quantify the predictive power of a subset of questions on rest of the universe, the following may be considered:

Consider the question subset S={Q1, Q2, . . . , Qk} and a universal set U of questions (i.e., S⊂U and k≦|U|)
Let U−S={U1, U2, . . . , Un}
Form an array P(S,U)={p1, p2, . . . , pn} where
   pj=min{PR(Q1, Uj), PR(Q2, Uj) . . . , PR(Qk, Uj)}

The predictive power of S on U−S is then inversely related to the sum of the array P(S, U) (which is denoted a s PR(S,U)) hereafter.

The optimization engine 202, then, can be configured to find a subset S of U

such that |S| is minimized, and the predictive power of S on U is maximized, i.e., PR(S, U) is minimized.

As touched on heretofore, a “fairness” parameter may also be employed by the optimization engine 202. This can be accomplished by ageing questions by way of achieving “fairness” (or, a more or less even distribution of questions over time, let alone an avoidance of a situation where certain questions are never utilized over a considerably long period of time). More particularly, since the selection of a question is clearly a pre-requisite for getting responses to the same, a mechanism using Algorithm 1 (see below) without an alteration for “fairness” may lead to “starvation”, i.e., certain questions end up not being selected at all, in turn diminishing their chances of being selected in the future. Thus, ageing can ensure fairness to some extent by increasing the probability of the selection of a question based on the number of times it was not previously selected.

Accordingly, an ageing parameter can be incorporated by scaling the weight of any question as a function of its age, e.g., of the number of times that the question has been discarded from S since h was last selected.

To find S from U, the following may be employed:

Greedy Algorithm
Rank a question qᵢ in terms of PR(qᵢ)=Σ_{qεQ} PR(qᵢ, q) in the increasing order of PR(qᵢ)

Optionally, scale PR(qᵢ)
S=Φ
Let q be the question in U−S which has the least value of PR(q)

While ((PR(S, Q)−PR(S∪q, U))>η or |S|<β)

S=S∪q
Output S

Thence, in an “end-to-end” optimizing system, a set of questions may be chosen using Algorithm 1. After each instance of the survey is administered, then Algorithm 1 (with ageing incorporated) can be reapplied, using updated data taking (which means updating the historical data store by adding any new content [e.g., newly gathered results] and re-applying the algorithm on the updated data store.

It is to be understood that the invention, in accordance with at least one embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

Generally, embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Generally, although illustrative embodiments of the present invention have been described herein with reference to the accompanying drawings, it is to be understood that the invention is not limited to those precise embodiments.

What is claimed is:

1. A method comprising:
providing a questionnaire to respondents, the questionnaire comprising questions selected from a question repository;
obtaining answers to the questionnaire from the respondents; and
automatically reestablishing the questionnaire based on previous answers from respondents.

2. The method according to claim 1, wherein said reestablishing comprises employing questions from the question repository.

3. The method according to claim 2, wherein said employing comprises selecting new questions from the question repository.

4. The method according to claim 1, further comprising:
weighting questions in the question repository;
said reestablishing comprising selecting questions based on said weighting.

5. The method according to claim 4, wherein said weighting comprises weighting each question as a function of aging since previous selection of each question.

6. The method according to claim 1, wherein the questions are pre-defined questions each having finite-answer sets.

7. The method according to claim 1, wherein said reestablishing comprises discerning value dependencies among respondents' answers.

8. The method according to claim 7, wherein said discerning comprises ascertaining a predictive power of given questions on other questions.

9. An apparatus comprising:
a main memory;
an optimization engine in communication with said main memory;
said optimization engine acting to:
provide a questionnaire to respondents, the questionnaire comprising questions selected from a question repository;
obtain answers to the questionnaire from the respondents; and
automatically reestablish the questionnaire based on previous answers from respondents.

10. The apparatus according to claim 9, wherein said optimization engine acts to reestablish the questionnaire via employing questions from the question repository.

11. The apparatus according to claim 10, wherein said optimization engine acts to reestablish the questionnaire via selecting new questions from the question repository.

12. The apparatus according to claim 9, wherein said optimization engine further acts to:
weight questions in the question repository; and
reestablish the questionnaire via selecting questions based on the weighting.

13. The apparatus according to claim 12, wherein said optimization engine acts to weight each question as a function of aging since previous selection of each question.

14. The apparatus according to claim 9, wherein the questions are pre-defined questions each having finite-answer sets.

15. The apparatus according to claim 9, wherein said optimization engine acts to reestablish the questionnaire via discerning value dependencies among respondents' answers.

16. The apparatus according to claim 15, wherein said optimization engine acts to discern value dependencies via ascertaining a predictive power of given questions on other questions.

17. A program storage device readable by machine, tangibly embodying a program of instructions executable by the machine to perform a method comprising:
providing a questionnaire to respondents, the questionnaire comprising questions selected from a question repository;
obtaining answers to the questionnaire from the respondents; and
automatically reestablishing the questionnaire based on previous answers from respondents.

18. The program storage device according to claim 17, wherein said reestablishing comprises employing questions from the question repository.

19. The program storage device according to claim 17, further comprising;
weighting questions in the question repository;
said reestablishing comprising selecting questions based on said weighting.

20. The program storage device according to claim 17, wherein said reestablishing comprises discerning value dependencies among respondents'answers.
